(19) United States
(12) Patent Application Publication
(10) Pub. No.: US 2023/0352738 A1
(43) Pub. Date: Nov. 2, 2023

(54) Non-Aqueous Electrolyte Solution for Lithium Secondary Battery and Lithium Secondary Battery Including the Same

(71) Applicants: SK ON CO., LTD., Seoul (KR); SK Innovation Co., Ltd., Seoul (KR)

(72) Inventors: Min Young Lee, Daejeon (KR); Chan Woo Kim, Daejeon (KR)

(21) Appl. No.: 18/128,567

(22) Filed: Mar. 30, 2023

(30) Foreign Application Priority Data
Mar. 31, 2022 (KR) 10-2022-0040289

(51) Int. Cl. H01M 10/0567; H01M 10/0569; H01M 10/0568; H01M 10/052

(52) U.S. Cl. CPC H01M 10/0567; H01M 10/052; H01M 10/0568; H01M 10/0569; H01M 2300/0028; H01M 2300/0051

(57) ABSTRACT

A non-aqueous electrolyte solution according to an embodiment of the present invention includes a non-aqueous organic solvent, a lithium salt, an additive including a first additive that includes a phosphorus-fluorine compound, and an auxiliary additive including a carbonate-based compound. A content of the first additive relative to a weight of the carbonate-based compound is in a range from 40 wt% to 110 wt%.

### CROSS-REFERENCE TO RELATED APPLICATION

This application claims priority to Korean Patent Application No. 10-2022-0040289 filed Mar. 31, 2022, the disclosure of which is hereby incorporated by reference in its entirety.

### BACKGROUND OF THE INVENTION

### 1. Field of the Invention

The present invention relates to a non-aqueous electrolyte solution and a lithium secondary battery including the same. More particularly, the present invention relates to a non-aqueous electrolyte solution including a non-aqueous solvent and an additive, and a lithium secondary battery including the same.

### 2. Description of Related Art

A secondary battery which can be charged and discharged repeatedly has been widely employed as a power source of a mobile electronic device such as a camcorder, a mobile phone, a laptop computer. Recently, a battery pack including the secondary battery is being developed and applied as a power source of an eco-friendly automobile such as a hybrid vehicle.

A lithium secondary battery is highlighted and developed among various types of secondary batteries due to high operational voltage and energy density per unit weight, a high charging rate, a compact dimension, etc.

For example, the lithium secondary battery may include an electrode assembly including a cathode, an anode and a separation layer (separator), and an electrolyte solution immersing the electrode assembly.

A lithium metal oxide may be used as a cathode active material of a lithium secondary battery. Examples of the lithium metal oxide include a nickel-based lithium metal oxide.

As an application range of the lithium secondary batteries is expanded, enhanced life-span, and higher capacity and operational stability are required. Accordingly, a lithium secondary battery that provides uniform power and capacity even during repeated charging and discharging is preferable.

However, power and capacity may be decreased due to surface damages of a nickel-based lithium metal oxide used as the cathode active material during the repeated charging and discharging, and side reactions between the nickel-based lithium metal oxide and the electrolyte may occur.

For example, as disclosed in Korean Published Patent Application No. 10-2019-0119615, etc., a method for improving battery properties by adding additives to a non-aqueous electrolyte for a lithium secondary battery is being researched.

### SUMMARY OF THE INVENTION

According to an aspect of the present invention, there is provided a non-aqueous electrolyte solution providing improved mechanical and chemical stability.

According to an aspect of the present invention, there is provided a lithium secondary battery including the non-aqueous electrolyte solution and having improved operational stability and electrical property.

A non-aqueous electrolyte solution includes a non-aqueous organic solvent, a lithium salt, an additive including a first additive that includes a phosphorus-fluorine compound, and an auxiliary additive comprising a carbonate-based compound. A content of the first additive relative to a weight of the carbonate-based compound is in a range from 40 wt% to 110 wt%.

In some embodiments, a content of the first additive may be in a range from 0.3 wt% to 1.2 wt% based on a total weight of the non-aqueous electrolyte solution.

In some embodiments, the first additive may include lithium difluoro bis(oxalato)phosphate.

In some embodiments, the additive may further include a second additive including an amino silane-based compound.

In some embodiments, the second additive may include 3-(trimethylsilyl)-2-oxazolidinone.

In some embodiments, a content of the second additive relative to a weight of the first additive may be in a range from 60 wt% to 140 wt%.

In some embodiments, the auxiliary additive may further include an alkyl sultone-based compound and an alkenyl sultone-based compound.

In some embodiments, a content of the auxiliary additive may be in a range from 1.1 wt% to 3.5 wt% based on a total weight of the non-aqueous electrolyte solution.

In some embodiments, the non-aqueous organic solvent may include at least one selected from the group consisting of ethylene carbonate (EC), ethyl methyl carbonate (EMC), dimethyl carbonate (DMC) and diethyl carbonate (DEC).

In some embodiments, the lithium salt may include at least one of lithium tetrafluoroborate (LiBF₄), lithium hexafluorophosphate (LiPF₆) and lithium difluorophosphate (LiPO₂F₂).

In some embodiments, the carbonate-based compound may include at least one of vinylene carbonate (VC), vinylethylene carbonate (VEC) and fluoroethylene carbonate (FEC).

A lithium secondary battery includes an electrode assembly including a cathode and an anode facing the cathode, and the non-aqueous electrolyte according to the above-described embodiments impregnating the electrode assembly.

A non-aqueous electrolyte solution according to embodiments of the present invention includes a first additive including a phosphorus-fluorine compound.

For example, the first additive may serve as a radical scavenger in the non-aqueous electrolyte solution. Accordingly, the first additive may capture and remove active radicals (e.g., an active oxygen) generated around the cathode active material, so that swelling of the battery may be prevented. Thus, battery capacity properties at a low temperature (e.g., -5° C. or lower) may be improved, and battery life-span properties during a storage at a high temperature (e.g., 45° C. or higher) may be improved.

For example, the first additive may adsorb HF and H₂O while forming a stable film on an electrode. Accordingly, high-temperature storage and life-span properties of the secondary battery may be improved.

In exemplary embodiments, the non-aqueous electrolyte solution may include an auxiliary additive containing a carbonate-based compound, and the first additive may be added in a predetermined content ratio with respect to the carbonate-based compound. Accordingly, low-temperature properties and high-temperature storage properties may be improved while reducing a battery resistance.

In some embodiments, a second additive including an amino silane-based compound may be further included. Accordingly, the radical removal and impurity adsorption effects may be further enhanced. Therefore, the low-temperature performance and high-temperature life-span characteristics of the battery may be further improved compared to the case where only the first additive is used or no additive is added.

### BRIEF DESCRIPTION OF THE DRAWINGS

FIGS. 1 and 2 are a schematic plan view and a schematic cross-sectional view, respectively, illustrating a lithium secondary battery in accordance with exemplary embodiments.

### DESCRIPTION OF THE INVENTION

According to embodiments of the present invention, a non-aqueous electrolyte including an additive is provided. Further, a lithium secondary battery including the non-aqueous electrolyte solution is also provided.

A non-aqueous electrolyte solution according to embodiments of the present invention includes an organic solvent, a lithium salt, an additive and an auxiliary additive.

The organic solvent may include an organic compound that provides sufficient solubility for the lithium salt, the additive and the auxiliary additive and has no substantial reactivity with the lithium secondary battery.

In example embodiments, the organic solvent may include a carbonate-based solvent, an ester-based solvent, an ether-based solvent, a ketone-based solvent, an alcohol-based solvent, an aprotic solvent, etc. These may be used alone or in a combination thereof.

For example, the carbonate-based solvent may include at least one selected from the group consisting of dimethyl carbonate (DMC), ethyl methyl carbonate (EMC), methyl propyl carbonate, ethyl propyl carbonate, diethyl carbonate (DEC), dipropyl carbonate, propylene carbonate (PC), ethylene carbonate (EC), fluoroethylene carbonate (FEC) and butylene carbonate.

For example, the ester-based solvent may include at least one selected from the group consisting of methyl acetate (MA), ethyl acetate (EA), n-propyl acetate (n-PA), 1,1-dimethylethyl acetate (DMEA), methyl propionate (MP), ethyl propionate (EP), γ-butyrolacton (GBL), decanolide, valerolactone, mevalonolactone and caprolactone, etc.

For example, the ether-based solvent may include at least one selected from the group consisting of dibutyl ether, tetraethylene glycol dimethyl ether (TEGDME), diethylene glycol dimethyl ether (DEGDME), dimethoxyethane, tetrahydrofuran (THF) and 2-methyltetrahydrofuran.

For example, the ketone-based solvent may include cyclohexanone, etc. For example, the alcohol-based solvent may include at least one of ethyl alcohol and isopropyl alcohol.

For example, the aprotic solvent may include at least one selected from the group consisting of a nitrile-based solvent, an amide-based solvent (e.g., dimethylformamide (DMF)), a dioxolane-based solvent (e.g., 1,3-dioxolane) and a sulfolane-based solvent.

In exemplary embodiments, the organic solvent may include the carbonate-based solvent, and the carbonate-based solvent may include at least one selected from the group consisting of ethylene carbonate (EC), ethylmethyl carbonate (EMC), dimethyl carbonate (DMC) and diethyl carbonate (DEC).

In exemplary embodiments, the lithium salt may serve as an electrolyte. For example, the lithium salt may be expressed as Li⁺X⁻.

Non-limiting examples of the anion X⁻ may include F⁻, Cl⁻, Br⁻, I⁻, NO₃⁻, N(CN)₂⁻, BF₄⁻, lO₄⁻, PF₆⁻, SbF₆⁻, AsF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, F₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻, (CF₃CF₂SO₂)₂N⁻, PO₂F₂⁻, etc. These may be used alone or in a combination thereof.

In some embodiments, the lithium salt may include at least one of LiBF₄, LiPF₆ and LiPO₂F₂. Accordingly, a film having improved thermal stability may be formed on an electrode surface. Thus, an ionic conductivity and electrode protection properties of the non-aqueous electrolyte solution may be improved.

In an embodiment, the lithium salt may be included in a concentration from about 0.01 M to 5 M, preferably from about 0.01 M to 2 M with respect to the non-aqueous organic solvent. Within the above range, transfer of lithium ions and/or electrons may be promoted during charging and discharging of the lithium secondary battery, so that improved capacity may be achieved.

In exemplary embodiments, the additive may include a first additive containing a phosphorus-fluorine-based compound.

The term “phosphorus-fluorine-based compound” used herein may refer to a compound containing phosphorus (P) and fluorine (F) together in one molecule. For example, the “phosphorus-fluorine compound” may include a compound in which phosphorus and fluorine are directly linked through a covalent bond in one molecule.

For example, when the secondary battery is stored at a high temperature, a thickness may be increased due to a swelling phenomenon. As a result, durability and stability of the secondary battery may be deteriorated. For example, when the secondary battery is stored at a low temperature, movement of lithium ions may be hindered, thereby deteriorating capacity properties.

According to exemplary embodiments of the present invention, the first additive containing the phosphorus-fluorine compound may serve as a radical scavenger in the non-aqueous electrolyte. Accordingly, the swelling phenomenon described above may be prevented by the first additive capturing and removing active radicals (e.g., active oxygen) generated around the cathode active material. Thus, battery capacity properties at a low temperature (e.g., -5° C. or lower) may be improved, and battery life-span properties during a storage at a high temperature (e.g., 45° C. or higher) may be improved.

Additionally, e.g., the first additive may adsorb HF and H₂O while forming a stable film on the electrode. Accordingly, high-temperature storage and life-span properties of the secondary battery may be improved.

In some embodiments, the first additive may include lithium difluoro bis(oxalate)phosphate. For example, capacity and life-span properties of the secondary battery may be further improved by lithium difluoro bis(oxalate)phosphate.

In some embodiments, a content of the first additive may be in a range from 0.3 weight percent (wt%) to 1.2 wt % based on a total weight of the non-aqueous electrolyte solution. For example, the content of the first additive may be 0.3 wt% or more, 0.4 wt% or more, 0.5 wt% or more, 0.6 wt% or more, or 0.7 wt% or more based on the total weight of the non-aqueous electrolyte solution. For example, the content of the first additive may be 1.2 wt% or less, 1.1 wt% or less, 1.0 wt% or less, 0.9 wt% or less, or 0.8 wt% or less based on the total weight of the non-aqueous electrolyte solution. In preferable embodiments, the content of the first additive may be in a range from 0.4 wt% to 1.1 wt%, from 0.5 wt% to 1.0 wt%, from 0.6 wt% to 0.9 wt%, or from 0.7 wt% to 0.8 wt% based on the total weight of the non-aqueous electrolyte solution.

Within the content range of the first additive, radical removal performance may be improved while reducing a battery resistance. Accordingly, a capacity retention at room temperature and high temperature storage properties may be improved.

For example, the additive may include only the first additive, or the first additive may be used together with a second additive different from the first additive.

In some embodiments, the additive may further include the second additive including an amino silane-based compound. For example, the amino silane-based compound may include a cyclic amino silane-based compound.

For example, the first additive and the second additive may be used together as the additive. Accordingly, the above-described radical removal and impurity adsorption performance may be further improved. Therefore, the low-temperature performance and high-temperature life-span properties of the lithium secondary battery may be further improved compared to the case of using only the first additive or the case not using the additive.

In some embodiments, the second additive may include 3-(trimethylsilyl)-2-oxazolidinone. In this case, a synergistic effect when the first additive and the second additive are added together may be sufficiently implemented.

In some embodiments, a content of the second additive may be in a range from 60 wt% to 140 wt% relative to a weight of the first additive. For example, the content of the second additive relative to the weight of the first additive may be 60 wt% or more, 70 wt% or more, 80 wt% or more, 90 wt% or more, or 100 wt% or more. For example, the content of the second additive relative to the weight of the first additive may be 140 wt% or less, 130 wt% or less, 120 wt% or less, or 110 wt% or less. In preferable embodiments, the content of the second additive relative to the weight of the first additive may be in a range from 60 wt% to 130 wt%, from 70 wt% to 120 wt%, from 80 wt% to 110 wt%, or from 90 wt% to 100 wt%.

Within the content range of the second additive, deterioration of the battery life-span properties in a high-temperature environment may be prevented while sufficiently implementing the synergistic effect as described above.

In some embodiments, a total content of the additive may be in a range from 0.3 wt% to 1.2 wt% based on the total weight of the non-aqueous electrolyte solution. For example, the total content of the additive may be 0.3 wt% or more, 0.4 wt% or more, 0.5 wt% or more, 0.6 wt% or more, or 0.7 wt% or more based on the total weight of the non-aqueous electrolyte solution. For example, the total content of the additive may be 1.2 wt% or less, 1.1 wt% or less, 1.0 wt% or less, 0.9 wt% or less, or 0.8 wt% or less based on the total weight of the non-aqueous electrolyte solution. In preferable embodiments, the total content of the additive may be in a range from 0.4 wt% to 1.1 wt%, from 0.5 wt% to 1.0 wt%, from 0.6 wt% to 0.9 wt%, or from 0.7 wt% to 0.8 wt% based on the total weight of the non-aqueous electrolyte solution.

Within the range of the total content of the additive, the radical removal performance may be improved while reducing the battery resistance. Accordingly, the capacity retention at room temperature and the high temperature storage properties may be improved. Within the total content range of the additive, in both cases of using only the first additive and using the first additive and the second additive, the life-span and storage properties may be improved while suppressing a resistance increase.

In exemplary embodiments, the above-described non-aqueous electrolyte solution may include an auxiliary additive including a carbonate-based compound.

In exemplary embodiments, the above-described non-aqueous electrolyte solution may include an auxiliary additive including a carbonate-based compound.

The carbonate-based compound may include, e.g., at least one of vinylene carbonate (VC), vinylethylene carbonate (VEC) and fluoroethylene carbonate (FEC).

In exemplary embodiments, a content of the first additive relative to the weight of the carbonate-based compound included in the auxiliary additive may be in a range from 40 wt% to 110 wt%. For example, the content of the first additive relative to the weight of the carbonate-based compound included in the auxiliary additive may be 40 wt% or more, 50 wt% or more, 60 wt% or more, or 70 wt% or more. For example, the content of the first additive relative to the weight of the carbonate-based compound included in the auxiliary additive may be 110 wt% or less, 100 wt% or less, 90 wt% or less, or 80 wt% or less. In preferable embodiments, the content of the first additive relative to the weight of the carbonate-based compound included in the auxiliary additive may be in a range from 50 wt% to 100 wt%, from 60 wt% to 90 wt%, or from 70 wt% to 80 wt%.

For example, if the content of the first additive is less than 40 wt% based on the weight of the carbonate-based compound, the content of the first additive may become excessively low to degrade the low-temperature properties and the battery life-span properties during the high-temperature storage.

For example, If the weight of the first additive exceeds 110 wt% based on the weight of the carbonate-based compound, the battery resistance may be increased, resulting in deterioration of capacity and power properties.

In some embodiments, the auxiliary additive may further include an alkyl sultone-based compound and an alkenyl sultone-based compound.

For example, the alkyl sultone-based compound may include at least one of 1,3-propane sultone (PS) and 1,4-butane sultone.

For example, the alkenyl sultone-based compound may include at least one of ethensultone, 1,3-propene sultone (PRS), 1,4-butene sultone and 1-methyl-1,3-propene sultone.

The above-described auxiliary additive may further include, e.g., an anhydride-based compound such as succinic anhydride and maleic anhydride, a nitrile-based compound such as glutaronitrile, succinic acid nitrile and adiponitrile. These may be used alone or in a combination thereof in addition to the above-mentioned sultone-based compound.

In an embodiment, the auxiliary additive may further include at least one of polyethylene sulfide (PES), vinylene carbonate (VC), vinylethylene carbonate (VEC), and ethylene sulfate (ESA).

In some embodiments, the content of the auxiliary additive may be in a range from 1.1 wt% to 3.5 wt% based on the total weight of the non-aqueous electrolyte solution. For example, the content of the auxiliary additive may be 1.1 wt% or more, 1.3 wt% or more, 1.5 wt% or more, 1.7 wt% or more, 1.9 wt% or more, 2.1 wt% or more, or 2.3 wt% or more based on the total weight of the non-aqueous electrolyte solution. For example, the content of the auxiliary additive may be 3.5 wt% or less, 3.3 wt% or less, 3.1 wt% or less, 2.9 wt% or less, 2.7 wt% or less, or 2.5 wt% or less based on the total weight of the non-aqueous electrolyte solution. In preferable embodiments, the content of the auxiliary additive may be in a range from 1.3 wt% to 3.3 wt%, from 1.5 wt% to 3.1 wt%, from 1.7 wt% to 2.9 wt%, from 1.9 wt% to 2.7 wt%, from 2.1 wt% to 2.5 wt% based on the total weight of the non-aqueous electrolyte solution.

Within the content range of the auxiliary additive, an excessive increase of the battery resistance may be suppressed and side reactions of the additive may be further suppressed. Accordingly, capacity reduction may be prevented while maintaining or improving an effect of improving the life-span properties of the secondary battery from the introduction of the above-described additive.

A lithium secondary battery according to embodiments of the present invention may include a cathode, an anode facing the cathode and the above-described non-aqueous electrolyte solution.

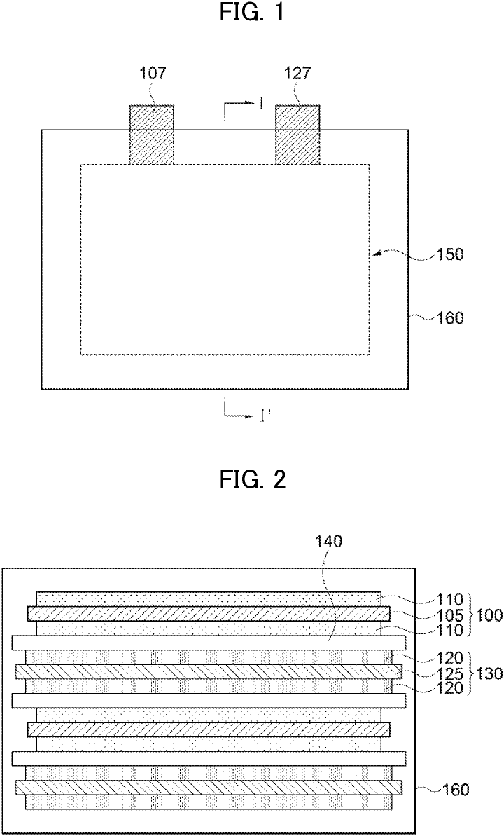

FIGS. 1 and 2 are a schematic plan view and a schematic cross-sectional view, respectively, illustrating a lithium secondary battery in accordance with exemplary embodiments. For example, FIG. 2 is a cross-sectional view taken along line I-I′ of FIG. 1.

Referring to FIGS. 1 and 2, the lithium secondary battery may include a cathode 100 and an anode 130 facing the cathode 100.

The cathode 100 may include a cathode current collector 105 and a cathode active material layer 110 on the cathode current collector 105.

The cathode active material layer 110 may include a cathode active material, and may further include a cathode binder and a conductive material.

The cathode active material may be a material capable of reversibly intercalating and deintercalating lithium ions. The cathode active material may include, e.g., a lithium metal oxide containing a metal element such as nickel, cobalt, manganese, aluminum, etc.

For example, the lithium metal oxide may be represented by Chemical Formula 1 below.

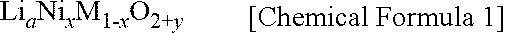

In Chemical Formula 1, 0.9≤a≤1.2, 0.5≤x≤0.99, -0.1≤y≤0.1, and M may include at least one element selected from Na, Mg, Ca, Y, Ti, Hf, V, Nb, Ta, Cr, Mo, W, Mn, Co, Fe, Cu, Ag, Zn, B, Al, Ga, C, Si, Sn, Ba and Zr.

As the content of Ni in the cathode active material or the lithium-transition metal oxide increases, chemical stability, high-temperature storage stability, etc., of the secondary battery may be relatively deteriorated. Further, sufficient high power/high capacity properties according to using the high-Ni content may not be achieved due to surface damages of the cathode active material or a side reaction with the non-aqueous electrolyte solution during repeated charge/discharge cycles.

However, the above-described first additive or the additive including the first additive and the second additive may capture/remove the active oxygen around the cathode active material or in the non-aqueous electrolyte solution. Accordingly, the high power/high capacity properties from high Ni content (e.g., 80 mol% or more of Ni) may be substantially uniformly maintained for a long period even in a high temperature environment.

For example, the cathode active material, the cathode binder, the conductive material, a dispersive agent, etc., may be mixed and stirred to prepare a cathode slurry. The cathode slurry may be coated on the cathode current collector 105, and then dried and pressed to form the cathode 100.

The cathode current collector 105 may include, e.g., stainless steel, nickel, aluminum, titanium, copper, or an alloy thereof, and may preferably include aluminum or an aluminum alloy.

For example, the binder may include an organic based binder such as polyvinylidenefluoride (PVDF), a polyvinylidene fluoride-hexafluoropropylene copolymer (PVDF-co-HFP), polyacrylonitrile, polymethylmethacrylate, etc., or an aqueous based binder such as styrene-butadiene rubber (SBR) that may be used with a thickener such as carboxymethyl cellulose (CMC).

For example, a PVDF-based binder may be used as the cathode binder. In this case, an amount of the binder for forming the cathode active material layer may be reduced, and an amount of the cathode active material may be relatively increased. Thus, capacity and power of the lithium secondary battery may be further improved.

The conductive material may be added to facilitate electron mobility between active material particles. For example, the conductive material may include a carbon-based material such as graphite, carbon black, graphene, carbon nanotube, etc., and/or a metal-based material such as tin, tin oxide, titanium oxide, a perovskite material such as LaSrCoO₃ or LaSrMnO₃, etc.

The anode 130 may include an anode current collector 125 and an anode active material layer 120 formed by coating an anode active material on the anode current collector 125.

The anode active material may include a material capable of adsorbing and ejecting lithium ions. For example, the anode active material may include a carbon-based material such as a crystalline carbon, an amorphous carbon, a carbon complex, a carbon fiber, etc., a lithium alloy, a silicon-based compound, tin, etc.

The amorphous carbon may include, e.g., a hard carbon, cokes a mesocarbon microbead (MCMB), a mesophase pitch-based carbon fiber (MPCF), etc.

The crystalline carbon may include, e.g., an artificial graphite, natural graphite, graphitized coke, graphitized MCMB, graphitized MPCF, etc.

For example, the lithium alloy may include a metal element such as aluminum, zinc, bismuth, cadmium, antimony, silicon, lead, tin, gallium, indium, etc.

The silicon-based compound may include, e.g., silicon, silicon oxide, a silicon-carbon composite compound such as silicon carbide (SiC).

For example, the anode active material may be mixed and stirred together with the above-described binder and conductive material, a thickener, etc., in a solvent to form a slurry. The slurry may be coated on at least one surface of the anode current collector 125, dried and pressed to obtain the anode 130.

A separation layer 140 may be interposed between the cathode 100 and the anode 130.

The separation layer 140 may include a porous polymer film prepared from, e.g., a polyolefin-based polymer such as an ethylene homopolymer, a propylene homopolymer, an ethylene/butene copolymer, an ethylene/hexene copolymer, an ethylene/methacrylate copolymer, or the like. The separation layer 140 may also include a non-woven fabric formed from a glass fiber with a high melting point, a polyethylene terephthalate fiber, or the like.

In some embodiments, an area and/or a volume of the anode 130 (e.g., a contact area with the separation layer 140) may be greater than that of the cathode 100. Thus, lithium ions generated from the cathode 100 may be easily transferred to the anode 130 without a loss by, e.g., precipitation or sedimentation.

In exemplary embodiments, an electrode cell may be defined by the cathode 100, the anode 130 and the separation layer 140, and a plurality of the electrode cells may be stacked to form the electrode assembly 150 that may have e.g., a jelly roll shape. For example, the electrode assembly 150 may be formed by winding, laminating or folding of the separation layer 140.

The electrode assembly 150 may be accommodated together with the non-aqueous electrolyte solution according to exemplary embodiments in a case 160 to define the lithium secondary battery.

For example, the non-aqueous electrolyte solution may immerse the electrode assembly.

As illustrated in FIG. 1, electrode tabs (a cathode tab and an anode tab) may protrude from the cathode current collector 105 and the anode current collector 125 included in each electrode cell to one side of the case 160. The electrode tabs may be welded together with the one side of the case 160 to be connected to an electrode lead (a cathode lead 107 and an anode lead 127) that may be extended or exposed to an outside of the case 160.

The lithium secondary battery may be fabricated into a cylindrical shape using a can, a prismatic shape, a pouch shape, a coin shape, etc.

Hereinafter, preferred embodiments are proposed to more concretely describe the present invention. However, the following examples are only given for illustrating the present invention and those skilled in the related art will obviously understand that various alterations and modifications are possible within the scope and spirit of the present invention. Such alterations and modifications are duly included in the appended claims.

### Example 1

### Preparation of Non-Aqueous Electrolyte Solution

A 1.0 M LiPF₆ solution was prepared using a mixed solvent of EC/EMC (25:75; volume ratio).

Thereafter, lithium difluoro bis(oxalato)phosphate (LiDFOP) as a first additive was added and mixed to the solution in an amount of 0.5 wt% based on a total weight of the non-aqueous electrolyte solution.

Further, as an auxiliary additive, 1.0 wt% of fluoroethylene carbonate (FEC), 0.5 wt% of 1,3-propane sultone (PS), 0.5 wt% 1,3-propene sultone (PRS) and 0.5 wt% of ethylene sulfate (ESA) were added based on a total weight of the non-aqueous electrolyte to form a non-aqueous electrolyte solution.

### Fabrication of Lithium Secondary Battery Sample

Li[Ni_{0.8}Co_{0.1}Mn_{0.1}]O₂ as a cathode active material, carbon black as a conductive material and polyvinylidene fluoride (PVdF) as a binder were mixed in a weight ratio of 92:5:3 to prepare a slurry. The slurry was uniformly coated on an aluminum foil having a thickness of 15 µm, vacuum dried and pressed at 130° C. to prepare a cathode for a lithium secondary battery.

95 wt% of natural graphite as an anode active material, 1 wt% of Super-P as a conductive material, 2 wt% of styrene-butadiene rubber (SBR) as a binder, and 2 wt% of carboxymethyl cellulose (CMC) as a thickener was mixed to prepare an anode slurry. The anode slurry was uniformly coated on a copper foil having a thickness of 15 µm, dried and pressed to form an anode.

The cathode and the anode prepared as described above were each notched by a predetermined size, and stacked with a separator (polyethylene, thickness: 20 µm) interposed therebetween to form an electrode cell. Each tab portion of the cathode and the anode was welded.

The welded assembly of the cathode/separator/anode was inserted in a pouch, and three sides of the pouch except for an electrolyte injection side were sealed. The tab portions were also included in sealed portions. The electrolyte solution as prepared in the above (1) was injected through the electrolyte injection side, and then the electrolyte injection side was also sealed. Impregnation was performed for more than 12 hours to obtain a lithium secondary battery.

### Example 2

A non-aqueous electrolyte solution and a lithium secondary battery were prepared by the same methods as those of Example 1, except that LiDFOP was added in an amount of 1.0 wt% based on the total weight of the non-aqueous electrolyte solution when preparing the non-aqueous electrolyte solution.

### Example 3

A non-aqueous electrolyte solution and a lithium secondary battery were prepared by the same methods as those of Example 1, except that 3-(trimethylsilyl)-2-oxazolidinone was further added as a second additive in an amount of 0.5 wt% based on the total weight of the non-aqueous electrolyte solution when preparing the non-aqueous electrolyte solution.

### Example 4

A non-aqueous electrolyte solution and a lithium secondary battery were prepared by the same methods as those of Example 1, except that LiDFOP was added to in an amount of 0.2 wt% based on the total weight of the non-aqueous electrolyte solution, and FEC was added in an amount of 0.5 wt% based on the total weight of the non-aqueous electrolyte solution when preparing the non-aqueous electrolyte solution.

### Example 5

A non-aqueous electrolyte solution and a lithium secondary battery were prepared by the same methods as those of Example 1, except that LiDFOP was added in an amount of 1.4 wt% based on the total weight of the non-aqueous electrolyte solution, and FEC was added in an amount of 1.5 wt% based on the total weight of the non-aqueous electrolyte solution when preparing the non-aqueous electrolyte solution.

### Example 6

A non-aqueous electrolyte solution and a lithium secondary battery were prepared by the same methods as those of Example 1, except that LiDFOP was added as a first additive in an amount of 0.6 wt% based on the total weight of the non-aqueous electrolyte solution, and 3-(trimethylsilyl)-2-oxazolidinone was further added as a second additive in an amount of 0.3 wt% based on the total weight of the non-aqueous electrolyte solution when preparing the non-aqueous electrolyte solution.

### Example 7

A non-aqueous electrolyte solution and a lithium secondary battery were prepared by the same methods as those of Example 1, except that LiDFOP was added as a first additive in an amount of 0.5 wt% based on the total weight of the non-aqueous electrolyte solution, and 3-(trimethylsilyl)-2-oxazolidinone was further added as a second additive in an amount of 0.75 wt% based on the total weight of the non-aqueous electrolyte solution when preparing the non-aqueous electrolyte solution.

### Example 8

A non-aqueous electrolyte solution and a lithium secondary battery were prepared by the same methods as those of in Example 1, except that 0.5 wt% of FEC, 0.2 wt% of PS, and 0.3 wt% of PRS were added as auxiliary additives based on the total weight of the nonaqueous electrolyte solution when preparing the non-aqueous electrolyte solution.

### Example 9

A non-aqueous electrolyte solution and a lithium secondary battery were prepared by the same methods as those of in Example 2, except that 2.0 wt% of FEC, 0.7 wt% of PS, 0.5 wt% of PRS and 0.5 wt% of ESA were added as auxiliary additives based on the total weight of the non-aqueous electrolyte when preparing the non-aqueous electrolyte solution.

### Comparative Example 1

A non-aqueous electrolyte and a lithium secondary battery were prepared by the same methods as those of in Example 1, except that additives were not added when preparing the non-aqueous electrolyte solution.

### Comparative Example 2

A non-aqueous electrolyte and a lithium secondary battery were prepared by the same methods as those of in Example 1, except that 3-(trimethylsilyl)-2-oxazolidinone as a second additive was added in an amount of 0.5 wt% based on the total weight of the non-aqueous electrolyte solution without adding the first additive when preparing the non-aqueous electrolyte solution.

### Comparative Example 3

A non-aqueous electrolyte and a lithium secondary battery were prepared by the same methods as those of in Example 1, except that LiDFOP was added in an amount of 0.35 wt% based on the total weight of the non-aqueous electrolyte solution when preparing the non-aqueous electrolyte solution.

### Comparative Example 4

A non-aqueous electrolyte and a lithium secondary battery were prepared by the same methods as those of in Example 1, except that LiDFOP was added in an amount of 1.2 wt% based on the total weight of the non-aqueous electrolyte solution when preparing the non-aqueous electrolyte solution.

The types and contents of additives and auxiliary additives used in the above Examples and Comparative examples are shown in Table 1 below.

TABLE 1

| No. | additive content | | | auxiliary additive content | | content of first additive relative to weight of carbonate-based compound (wt%) |
|---|---|---|---|---|---|---|
| | first additive (wt%) | second additive (wt%) | content of second additive relative to first additive (wt%) | carbonate-based additive (wt%) | total content of auxiliary additive (wt%) | |
| Example 1 | 0.5 | - | - | 1.0 | 2.5 | 50 |
| Example 2 | 1.0 | - | - | 1.0 | 2.5 | 100 |
| Example 3 | 0.5 | 0.5 | 100 | 1.0 | 2.5 | 50 |
| Example 4 | 0.2 | - | - | 0.5 | 2.5 | 40 |
| Example 5 | 1.4 | - | - | 1.5 | 2.5 | 107 |
| Example 6 | 0.6 | 0.3 | 50 | 1.0 | 2.5 | 60 |
| Example 7 | 0.5 | 0.75 | 150 | 1.0 | 2.5 | 50 |
| Example 8 | 0.5 | - | - | 0.5 | 1.0 | 100 |
| Example 9 | 1.0 | - | - | 2.0 | 3.7 | 50 |
| Comparative Example 1 | - | - | - | 1.0 | 2.5 | - |
| Comparative Example 2 | - | 0.5 | - | 1.0 | 2.5 | - |
| Comparative Example 3 | 0.35 | - | - | 1.0 | 2.5 | 35 |
| Comparative Example 4 | 1.2 | - | - | 1.0 | 2.5 | 120 |

### Experimental Example

### Evaluation on Initial Performance

### 1) Measurement of Initial Discharge Capacity

Each lithium secondary battery of Examples and Comparative Examples was charged (CC-CV 1.0 C 4.2 V 0.05 C CUT-OFF) and discharged (CC 1.0 C 3.0 V CUT-OFF) at room temperature (25° C.) once to measure an initial discharge capacity.

### 2) Measurement of Initial Discharge DCIR

The C-rate was sequentially increased in an order of 0.2 C, 0.5 C, 1.0 C, 1.5 C, 2.0 C, 2.5 C, and to 3.0 at an SOC (State of Charge) 60% of each lithium secondary battery of Examples and Comparative Examples. A voltage when charging and discharging proceeded for 10 seconds at each corresponding C-rate was plotted, and a slope was adopted as an initial discharge DCIR (direct current internal resistance).

### Evaluation on High Temperature Storage Properties (60° C.)

Each lithium secondary battery of Examples and Comparative Examples was left in a chamber of 60° C. for 5 weeks, and then the following evaluation was performed.

### 1) Evaluation on Battery Thickness Increase Ratio

An initial thickness of each lithium secondary battery according to Examples and Comparative Examples before being left in the chamber at 60° C. was measured using a plate thickness measuring device (Mitutoyo, 543-490B).

A thickness of the lithium secondary battery after being left in the chamber at 60° C. for 5 weeks was measured using the same device.

A thickness increase ratio was calculated as a percentage by dividing the thickness measured after the high-temperature storage by the initial thickness.

$$\begin{matrix}\text{Thickness increase ratio} \left(\%\right) = \\ \left(\text{battery thickness after the storage at high}\right) \\ \left(\text{temperature} / \text{initial battery thickness}\right) * 100\end{matrix}$$

### 2) Evaluation on Resistance Increase Ratio

The discharge DCIR of the lithium secondary battery according to Examples and Comparative Examples was measured by the same method as that in Experimental Example (1) 2).

A resistance increase ratio was calculated as a percentage by dividing the measured discharge DCIR by the initial discharge DCIR measured in Experimental Example (1) 2).

$$\begin{matrix}\text{Resistance increase ratio} \left(\%\right) = \\ \left(\text{discharge DCIR after the high temperature strorage} /\right) \\ \left(\text{initial discharge DCIR}\right) * 100\end{matrix}$$

### 3) Evaluation on Capacity Recovery

After the storage in the chamber at 60° C. for 5 weeks, each lithium secondary battery according to Examples and Comparative Examples was discharged once (CC 1.0 C 3.0 V CUT-OFF), and then charged (CC-CV 1.0 C 4.2 V 0.05 C CUT-OFF) and discharged (CC 1.0 C 3.0 V CUT-OFF) once to measure a discharge capacity.

A capacity recovery was calculated as a percentage by dividing the measured discharge capacity by the initial discharge capacity measured in Experimental Example (1) 1).

$$\begin{matrix}\text{Capacity recovery} \left(\%\right) = \\ \left(\text{discharge capacity after high temperature storage}\right) / \text{initial} \\ \left(\text{discharge capacity}\right) * 100\end{matrix}$$

### Evaluation on Low Temperature Performance

### 1) Evaluation on Low Temperature Capacity

Each lithium secondary battery according to Examples and Comparative Exampleswas charged (CC-CV 1.0 C 4.2V 0.05C CUT-OFF) and discharged (CC 1.0C 3.0V CUT-OFF) at -10° C. once to measure a charge capacity and a discharge capacity.

### 2) Measurement of Low-Temperature Discharge DCIR

The discharge DCIR of the lithium secondary battery according to Examples and Comparative Examples was measured under -10° C. by the same method as that of Experimental Example (1) 3).

### Evaluation on High Temperature Capacity Retention (45° C.)

Each lithium secondary battery according to Examples and Comparative Examples was charged (CC/CV ⅓C 4.2V 0.05C CUT-OFF) and discharged (CC ⅓C 2.5V CUT-OFF) in a chamber of 45° C. repeatedly with 100 cycles.

A capacity retention of the lithium secondary battery was calculated as a percentage by dividing the discharge capacity measured at the 100th cycle by an initial discharge capacity measured in Experimental Example (1) 1).

$$\begin{matrix}\text{Capacity retention rate =} \\ \left(\text{100th discharge capacity} / \text{initial} \text{discharge} \text{capacity}\right) \times 100 \\ \left(\%\right)\end{matrix}$$

The evaluation results are shown in Table 2 and Table 3 below.

TABLE 2

| No. | initial performance | | low temperature (-10° C.) performance | |
|---|---|---|---|---|
| | discharge capacity (mAh) | DCIR (mΩ) | discharge capacity (mAh) | DCIR (mΩ) |
| Example 1 | 1751 | 39.3 | 913 | 145.1 |
| Example 2 | 1751 | 39.6 | 982 | 138.6 |
| Example 3 | 1750 | 37.7 | 920 | 143.9 |
| Example 4 | 1735 | 38.5 | 892 | 149.3 |
| Example 5 | 1755 | 40.5 | 905 | 151.2 |
| Example 6 | 1752 | 37.9 | 915 | 144.5 |
| Example 7 | 1741 | 38.0 | 897 | 148.2 |
| Example 8 | 1750 | 38.8 | 913 | 149.1 |
| Example 9 | 1731 | 40.9 | 895 | 151.3 |
| Comparative Example 1 | 1740 | 37.6 | 867 | 158.1 |
| Comparative Example 2 | 1718 | 36.6 | 826 | 143.8 |
| Comparative Example 3 | 1723 | 38.1 | 780 | 145.2 |
| Comparative Example 4 | 1710 | 45.0 | 812 | 162.5 |

TABLE 3

| No. | high temperature (60° C.) storage property | | | capacity retention (45° C., 100cyc) (%) |
|---|---|---|---|---|
| | thickness increase ratio (%) | resistance increase ratio (%) | capacity recovery (%) | |
| Example 1 | 5.0 | 5.1 | 92 | 94 |
| Example 2 | 4.5 | 4.5 | 94 | 96 |
| Example 3 | 4.1 | 4.2 | 96 | 98 |
| Example 4 | 6.2 | 6.1 | 89 | 89 |
| Example 5 | 3.7 | 4.0 | 95 | 96 |
| Example 6 | 5.8 | 5.6 | 92 | 95 |
| Example 7 | 6.2 | 6.5 | 90 | 93 |
| Example 8 | 4.4 | 4.5 | 90 | 92 |
| Example 9 | 4.8 | 5.1 | 91 | 94 |
| Comparative Example 1 | 38 | 38.5 | 75 | 79 |
| Comparative Example 2 | 8.2 | 15.6 | 87 | 85 |
| Comparative Example 3 | 25.5 | 23.7 | 83 | 88 |
| Comparative Example 4 | 9.4 | 9.5 | 88 | 91 |

Referring to Tables 2 and 3, in the lithium secondary batteries of Examples where the first additive was added to the non-aqueous electrolyte solution together with the carbonate-based compound within an appropriate content ratio, generally improved initial performance, low-temperature performance, high-temperature performance and high temperature capacity retention were achieved compared to those from the lithium secondary batteries of Comparative Examples.

In Example 3, the first additive and the second additive were used together within an appropriate content ratio, so that low-temperature and high-temperature properties were improved compared to those from other Examples where only the first additive was used.

In Example 4, the content of the first additive was less than 0.3 wt% based on the total weight of the non-aqueous electrolyte solution, and low-temperature performance, high-temperature storage properties and high-temperature capacity retention were relatively lowered.

In Example 5, the content of the first additive was greater than 1.2 wt% based on the total weight of the non-aqueous electrolyte solution, and the resistance was relatively increased.

In Example 6, the content of the second additive was less than 60 wt% based on the weight of the first additive, and an additional synergistic effect through the second additive was not sufficiently implemented. Accordingly, low-temperature performance, high-temperature storage properties and high-temperature capacity retention were relatively lowered.

In Example 7, the content of the second additive exceeded 140 wt% based on the weight of the first additive, and low-temperature performance, high-temperature storage properties and high-temperature capacity retention were relatively lowered.

In Example 8, the content of the auxiliary additive was less than 1.1 wt% based on the total weight of the non-aqueous electrolyte, life-span and storage properties were relatively lowered.

In Example 9, the content of the auxiliary additive relative to the total weight of the non-aqueous electrolyte solution was greater than 3.5 wt%, and the battery resistance was relatively increased. Accordingly, the initial capacity was relatively lowered.

1. A non-aqueous electrolyte solution, comprising:
a non-aqueous organic solvent;
a lithium salt;
an additive comprising a first additive that includes a phosphorus-fluorine compound; and
an auxiliary additive comprising a carbonate-based compound,
wherein a content of the first additive relative to a weight of the carbonate-based compound is in a range from 40 wt% to 110 wt%.

2. The non-aqueous electrolyte solution according to claim 1, wherein a content of the first additive is in a range from 0.3 wt% to 1.2 wt% based on a total weight of the non-aqueous electrolyte solution.

3. The non-aqueous electrolyte solution according to claim 1, wherein the first additive comprises lithium difluoro bis(oxalato)phosphate.

4. The non-aqueous electrolyte solution according to claim 1, wherein the additive further comprises a second additive comprising an amino silane-based compound.

5. The non-aqueous electrolyte solution according to claim 4, wherein the second additive comprises 3-(trimethylsilyl)-2-oxazolidinone.

6. The non-aqueous electrolyte solution according to claim 4, wherein a content of the second additive relative to a weight of the first additive is in a range from 60 wt% to 140 wt%.

7. The non-aqueous electrolyte solution according to claim 1, wherein the auxiliary additive further comprises an alkyl sultone-based compound and an alkenyl sultone-based compound.

8. The non-aqueous electrolyte solution according to claim 1, wherein a content of the auxiliary additive is in a range from 1.1 wt% to 3.5 wt% based on a total weight of the non-aqueous electrolyte solution.

9. The non-aqueous electrolyte solution according to claim 1, wherein the non-aqueous organic solvent comprises at least one selected from the group consisting of ethylene carbonate (EC), ethyl methyl carbonate (EMC), dimethyl carbonate (DMC) and diethyl carbonate (DEC).

10. The non-aqueous electrolyte solution according to claim 1, wherein the lithium salt comprises at least one of lithium tetrafluoroborate (LiBF₄), lithium hexafluorophosphate (LiPF₆) and lithium difluorophosphate (LiPO₂F₂).

11. The non-aqueous electrolyte solution according to claim 1, wherein the carbonate-based compound comprises at least one of vinylene carbonate (VC), vinylethylene carbonate (VEC) and fluoroethylene carbonate (FEC).

12. A lithium secondary battery, comprising:
an electrode assembly comprising a cathode and an anode facing the cathode; and
the non-aqueous electrolyte of claim 1 impregnating the electrode assembly.
